(19) United States
(12) Patent Application Publication
(10) Pub. No.: US 2026/0094183 A1
(43) Pub. Date: Apr. 2, 2026

(54) AUDIENCE BUILD CONFIGURATIONS

(71) Applicant: Walmart Apollo, LLC, Bentonville, AR (US)

(72) Inventors: Manasij Sur Roy, Bangalore (IN); Chellapriyadharshini Maharajan, Bangalore (IN); Prathamesh Wagh, Bangalore (IN); Sutirtha Chakraborty, Bangalore (IN); Sanjoy Bose, Bangalore (IN)

(21) Appl. No.: 19/345,168

(22) Filed: Sep. 30, 2025

Related U.S. Application Data
(60) Provisional application No. 63/701,735, filed on Oct. 1, 2024.

(51) Int. Cl. G06Q 30/0251; G06Q 30/0242

(52) U.S. Cl. CPC G06Q 30/0251; G06Q 30/0244

(57) ABSTRACT

Systems and methods for generating an audience for a campaign are disclosed. An example system receives, from a user device, a request to generate an audience for a campaign. The system determines an audience intent based on the request and an audience parameter included in the request. The system extracts, based on the audience intent, attributes for products associated with the request, selects a product based on the attributes for products associated with the request, and generates a recommended audience build configuration for the product. The system further causes presentation of the recommended audience build configuration at the user device, and in response to selection of the recommended audience build configuration, generates the audience for the campaign based on the recommended audience build configuration.

### CROSS REFERENCE TO RELATED APPLICATION

This application claims benefit to U.S. Patent Application No. 63/701,735, entitled “AUDIENCE BUILD CONFIGURATIONS,” filed on Oct. 1, 2024, the disclosure of which is incorporated herein by reference in its entirety.

### TECHNICAL FIELD

This application relates generally to an audience building generation model, and more particularly, to a system for generating and presenting audience build configurations for campaigns and initiating campaigns based on a selected audience build configuration.

### BACKGROUND

Advertisements can be categorized into different segments (or audiences) based on predefined requirements. Existing systems allow users to search databases to identify relative segments. To this point, existing systems present multiple options to users that allow users to build segments. However, these systems require to users to have substantial knowledge about the available options and available segments to identify segments that meet requirements. Without the appropriate knowledge, users create or use sub-optimal segments for their advertisement campaigns, which results into decreased performance of the campaign. Additionally, existing systems are required to define multiple options and/or combinations of options to allow users to customize segments. These system requirements place considerable design constraints on existing systems.

Thus, there is a need for new solutions for generating and implementing audience build configurations.

### SUMMARY

The system and methods disclosed herein provide solutions for generating and implementing audience build configurations. An audience, in some embodiments, means an advertisement segment. The system and methods disclosed herein generate audience build configurations for (advertising) campaigns using one or more machine-learning systems. The system and methods disclosed herein simplify the creation of audience build configurations by using machine-learning models that can interpret and extract information from user request or queries. The extracted information is used to create and/or identify audience build configurations that meet user requirements without having the system to define multiple options and/or combinations of options. Additionally, the identified audience build configurations are converted into a human readable text format and presented to the users for selection. The audience build configurations can be presented with an explanation for criteria and/or factors used to generate the audience build configurations. This allows the systems and methods to present the audience build configurations in a user-friendly interface. Additionally, the systems and methods disclose herein, reduce user inputs by optimizing the generation of audience build configurations to a two-step process.

In some embodiments, the systems and method disclosed herein allow users to describe an audience brief using natural language text, which is used to generate a predetermined number (e.g., at least two, at least 3, etc.) audience build configurations (e.g., settings or requirements defining an audience). The audience brief can include information related to what sort of audiences the user wants to target, and the systems and methods can interpret the user's intent and recommend audience build configurations. In some embodiments, an audience build configuration includes a build configuration template auto filled with recommended options matched with the user's audience brief. The predetermined number of audience build configurations can including a mix of new and pre-built audiences, with each audience build configuration being closely matched to the users'query and/or request. Users are able to select one of the recommended audience build configurations to build an audience and initiate an (advertisement) campaign using the audience.

In various embodiments, a system for generating an audience for a campaign is disclosed. The system includes a non-transitory memory and a processor communicatively coupled to the non-transitory memory. The processor is configured to read a set of instructions to receive, from a user device, a request to generate an audience for a campaign. The processor is further configured to read a set of instructions to determine an audience intent based on, at least, the request and an audience parameter included in the request, and extract, based on the audience intent, attributes for products associated with the request. The processor is further configured to read a set of instructions to select a product based on the attributes for products associated with the request, and generate a recommended audience build configuration for the product. The processor is further configured to read a set of instructions to cause presentation of the recommended audience build configuration at the user device, and in response to selection of the recommended audience build configuration, generate the audience for the campaign based on the recommended audience build configuration.

In various embodiments, a computer-implemented method for generating an audience for a campaign is disclosed. The computer-implemented method includes steps of receiving, from a user device, a request to generate an audience for a campaign. The request can include an audience parameter. The computer-implemented method includes steps of determining an audience intent based on, at least, the request and the audience parameter, and extracting, based on the audience intent, attributes for products associated with the request. The computer-implemented method includes steps of selecting a product based on the attributes for products associated with the request. The computer-implemented method includes steps of generating a recommended audience build configuration for the product, and causing presentation of the recommended audience build configuration at the user device. The computer-implemented method includes steps of, in response to selection of the recommended audience build configuration, generating the audience for the campaign based on the recommended audience build configuration.

In various embodiments, a non-transitory computer readable medium having instructions stored thereon is disclosed. The instructions, when executed by at least one processor, cause at least one device to perform operations including receiving, from a user device, a request to generate an audience for a campaign. The request can include an audience parameter. The instructions, when executed by at least one processor, cause at least one device to perform operations including determining an audience intent based on, at least, the request and the audience parameter, and extracting, based on the audience intent, attributes for products associated with the request. The instructions, when executed by at least one processor, cause at least one device to perform operations including selecting a product based on the attributes for products associated with the request. The instructions, when executed by at least one processor, cause at least one device to perform operations including generating a recommended audience build configuration for the product, and causing presentation of the recommended audience build configuration at the user device. The instructions, when executed by at least one processor, cause at least one device to perform operations including, in response to selection of the recommended audience build configuration, generating the audience for the campaign based on the recommended audience build configuration.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

Various examples will be described below with reference to the following figures.

FIG. 1 illustrates a network environment configured to generate an audience for a campaign, in accordance with some embodiments.

FIG. 2 illustrates a block diagram of a computing device, in accordance with some embodiments.

FIGS. 3A and 3B illustrate an example user interface for interacting with a system for generating an audience build configuration, in accordance with some embodiments.

FIG. 4 illustrates an example audience builder configuration system, in accordance with some embodiments.

FIG. 5 illustrates an audience build configuration recommender system, in accordance with some embodiments.

FIG. 6 illustrates fine-tunning of a machine-learning model, in accordance with some embodiments.

FIG. 7 is a flowchart illustrating a method for generating an audience for a campaign, in accordance with some embodiments.

### DETAILED DESCRIPTION

This description of example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for generating an audience for a campaign. The methods and systems for generating an audience for a campaign use natural language text to recommend an optimal set of recommended audience build configurations the substantially match a user query and/or request. The user query and/or request include a brief description of a target audience, and are used by the methods and systems to determine requirements and interpret a user intent. The determined requirements and interpreted user intents are used to recommended audience build configurations. Each recommended audience build configuration can include a template automatically filled with recommended options matched with the user query and/or request. In some embodiments, the recommended audience build configurations are based on previously built audiences. The methods and systems further allow users to select a recommended audience build configuration to build a campaign (e.g., an ad campaign or a marketing campaign).

The methods and systems disclosed herein provide a two-step process generating audiences for campaigns. Compared to existing solution (which can include five or more steps), the methods and systems disclosed provide an optimal solution for generating audiences for campaigns. As such, the methods and systems disclosed provide a fast, optimal, and friction-less way to build audiences.

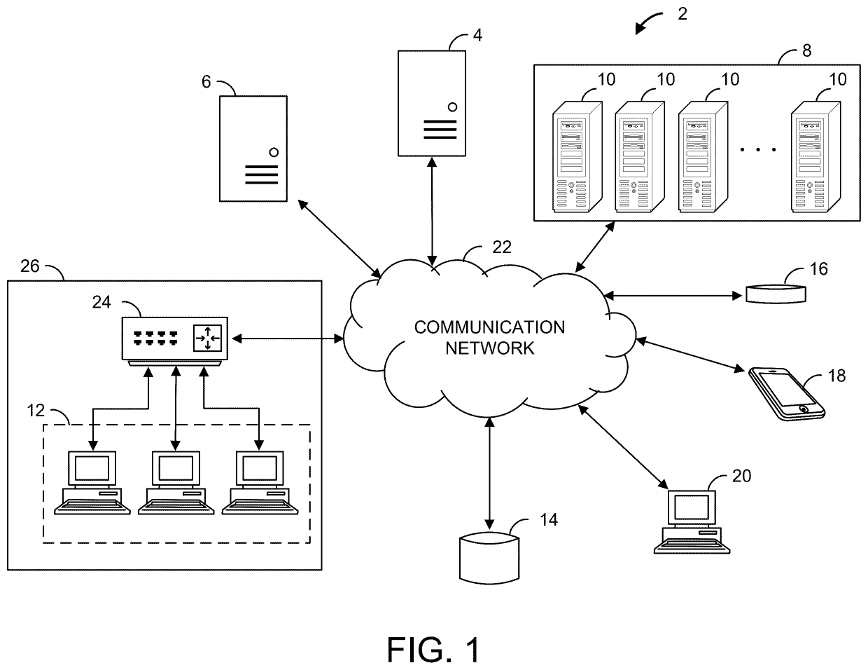

FIG. 1 illustrates a network environment 2 configured to generate an audience for a campaign, in accordance with some embodiments. The network environment 2 includes a plurality of devices or systems configured to communicate over one or more network channels, illustrated as a network cloud 22. For example, in various embodiments, the network environment 2 may include, but is not limited to, an audience configuration computing device 4, a web server 6, a cloud-based engine 8 including one or more processing devices 10, a database 14, and/or one or more user computing devices 16, 18, 20 operatively coupled over the network 22. The audience configuration computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the audience configuration computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the audience configuration computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the audience configuration computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the audience configuration computing device 4, for example. The workstation(s) 12 may communicate with the audience configuration computing device 4 over the communication network 22. The workstation(s) 12 may send data to, and receive data from, the audience configuration computing device 4. For example, the workstation(s) 12 may transmit data related to tracked operations performed at the physical location 26 to the audience configuration computing device 4.

Although FIG. 1 illustrates three user computing devices 16, 18, 20, the network environment 2 may include any number of user computing devices 16, 18, 20. Similarly, the network environment 2 may include any number of the audience configuration computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the audience configuration computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser or programs operating on the user computing devices, perform various operations such as provide and/or define one or more audience parameters and/or product parameters, search one or more databases associated with product attributes and/or user attributes, initiate one or more operations for generating a campaign based on an audience build configuration, review audience build configurations, modify audience build configurations, implement an audience build configuration, etc. The website may capture user requests including audience parameters and/or product parameters, and transmit the request to the audience configuration computing device 4 over the communication network 22. The website may also allow the user to interact with one or more of interface elements to perform specific operations, such as selecting an audience configuration build for initiating a campaign.

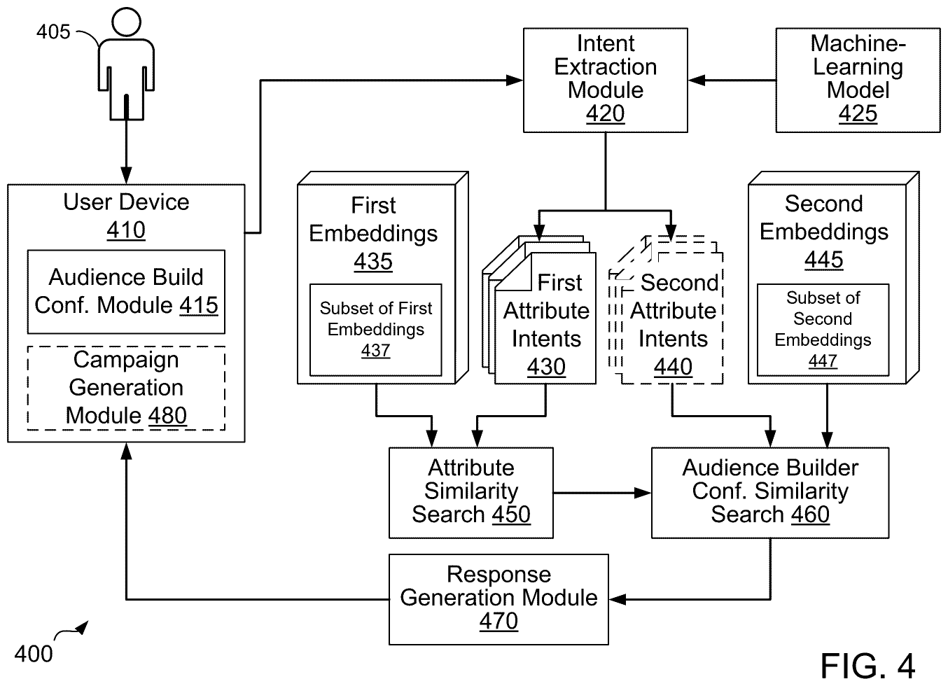

In some embodiments, the audience configuration computing device 4 may execute one or more models, processes, or algorithms, such as an intent extraction module 420 and a machine-learning model 425 (FIG. 4), to receive and/or transform the request, determine one or more products and/or audience attributes based on the received and/or transformed request, determine audience build configurations, recommend audience build configurations, and/or perform other operations described below. The audience configuration computing device 4 may transmit recommend audience build configurations and related data to the web server 6 over the communication network 22, and the web server 6 may generate campaigns based on the recommend audience build configurations and/or perform one or more operations based on the recommend audience build configurations.

The audience configuration computing device 4 is further operable to communicate with the database 14 over the communication network 22. For example, the audience configuration computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the audience configuration computing device 4, in some embodiments, the database 14 may be a local storage device, such as a hard drive, a non-volatile memory, or a USB stick. The audience configuration computing device 4 may store interaction data received from the web server 6 in the database 14. The audience configuration computing device 4 may also receive from the web server 6 user session data identifying events associated with browsing sessions, and may store the user session data in the database 14.

In some embodiments, the audience configuration computing device 4 assigns one or more models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, the audience configuration computing device 4 may generate one or more audience build configurations to be added to, distributed to, and/or stored in the database and/or communicatively coupled devices via the communication network 22.

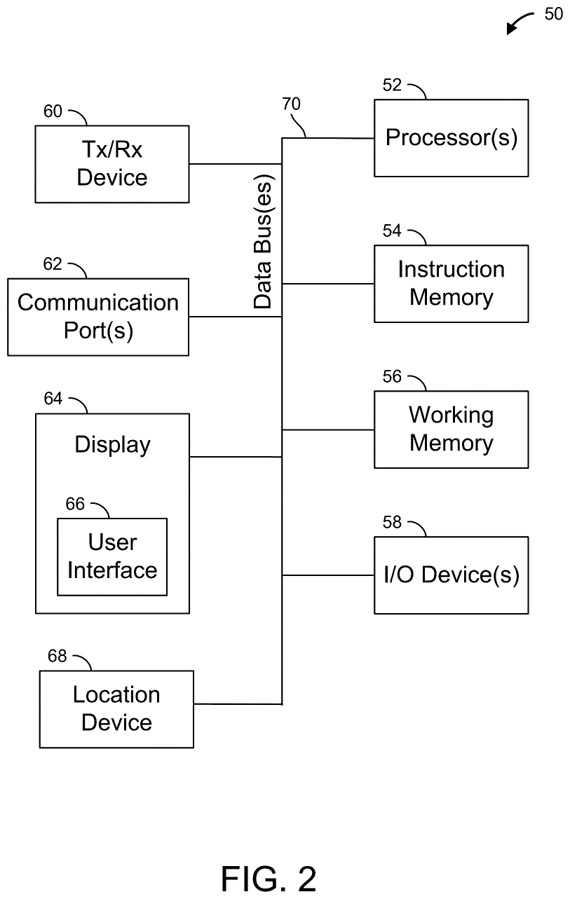

FIG. 2 illustrates a block diagram of a computing device 50, in accordance with some embodiments. In some embodiments, each of the audience configuration computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for generating audience build configurations and/or recommending audience build configurations, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, . NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with extracted attributes. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

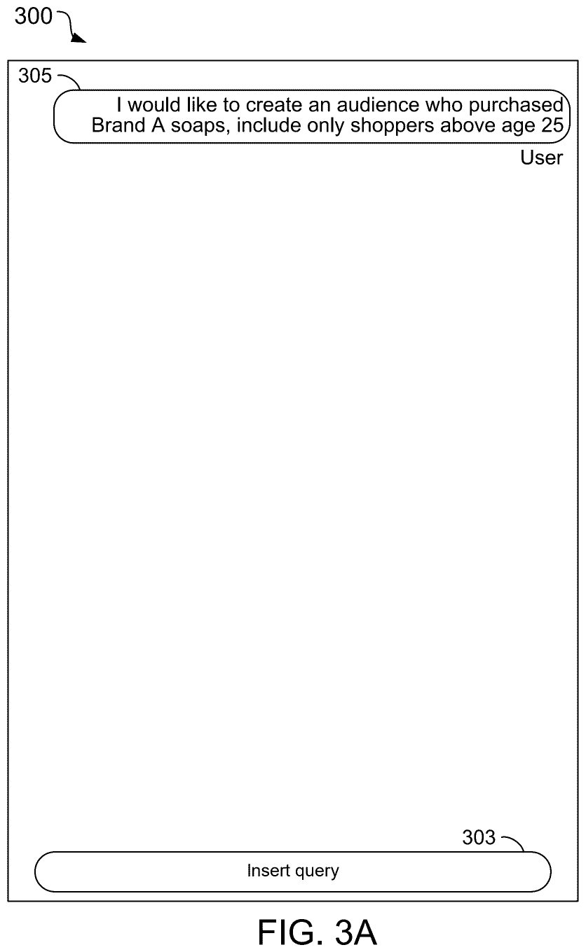

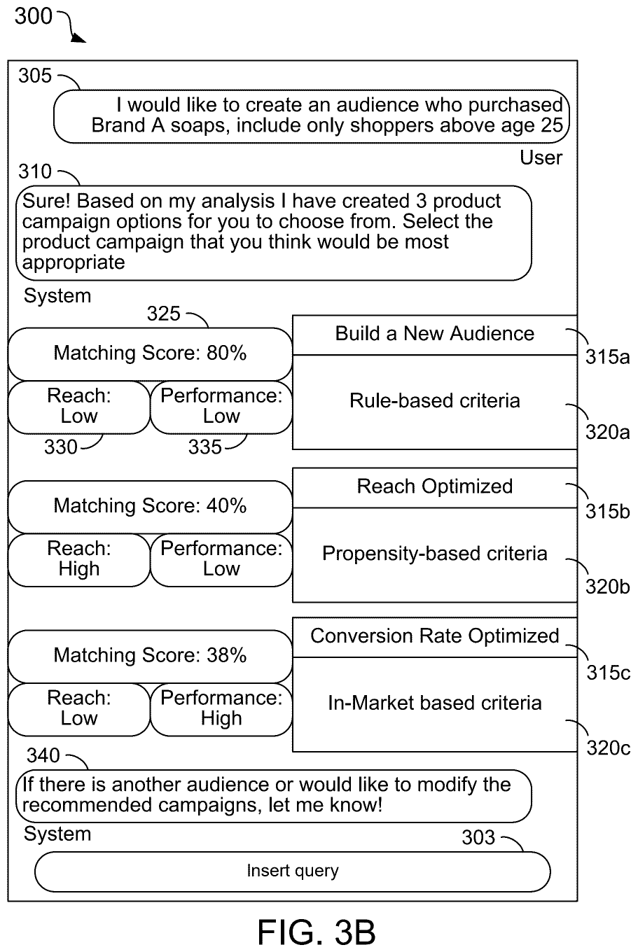

FIGS. 3A and 3B illustrate an example user interface for interacting with a system for generating an audience build configuration, in accordance with some embodiments. An audience builder user interface (UI) 300 can be presented at a user device (e.g., one or more user computing devices 16, 18, 20) and/or any other device described above in reference to FIG. 1. The audience builder user interface 300 includes one or more UI elements and/or UI input fields. For example, in FIG. 3A, the audience builder UI 300, at a first point in time, includes a user message UI element 305 and a text input field 303, where the user message UI element 305 corresponds to a request provided by a user via the text input field 303. The user message UI element 305 includes a request including one or more audience parameters and/or product parameters. For example, user message UI element 305 requests “I would like to create an audience who purchased Brand A soaps, include only shoppers above age 25.” The request is provided to an audience builder configuration system 400 (FIG. 4) to generate a response and/or one or more recommended audience build configurations, as described below. In some embodiments, the UI input fields can include image data input fields, document input fields, and/or other input fields.

Turning to FIG. 3B, at a second point in time, the audience builder UI 300 include response message UI elements 310 and 340 and/or one or more recommended audience build configuration UI elements 315. The response message UI elements 310 and 340 and the one or more recommended audience build configuration UI elements 315 are generated by the audience builder configuration system 400. A first response message UI element 310 is responsive to the user message UI element 305, and provides a natural language text response. For example, first response message UI element 310 informs the user that three product campaign options are recommended based on the user's query requesting to create an audience for people who purchased brand A soaps and are older than 25 years old.

The recommended audience build configuration UI elements 315 represent each of the recommended audience build configurations. For example, as shown in FIG. 3B, the audience builder UI 300 includes a first recommended audience build configuration 315a (e.g., “Build a New Audience”), a second recommended audience build configuration 315b (e.g., “Reach Optimized”), a third recommended audience build configuration 315c (e.g., “Conversion Rate Optimized”). In some embodiments, each of the build configuration UI elements 315 is presented with a respective criteria UI element 320. The criteria UI elements 320 describe and/or provide an explanation of the criteria and/or rules used to generate the recommended audience build configuration, as well as provide additional information on the targeted audience. For example, a first criteria UI element 320a indicates that the first recommended audience build configuration 315a was generated using rule-based criteria, a second criteria UI element 320b indicates that the second recommended audience build configuration 315b was generated using propensity-based criteria, and a third criteria UI element 320c indicates that the third recommended audience build configuration 315c was generated using in-market based criteria.

In some embodiments, each of the build configuration UI elements 315 can be presented with respective score UI element 325 and audience impact UI elements (e.g., reach score UI element 330 and performance UI element 335). The score UI element 325 can represent a matching score (e.g., how closely the recommendation aligns with the user request). The reach score UI element 330 can represent how many people may interact with or be aware of a campaign. The performance UI element 335 can represent a conversion rate for a campaign. The above-example UI elements are non-limiting and additional information can be presented to the user.

The user can select a recommended audience build configuration 315 that suits their initial request and build or generate a campaign using the recommended audience build configuration. If the recommended audience build configurations 315 do not satisfy or meet the user needs, the user can modify the recommended audience build configurations (e.g., using the text input field 303) or provide a new request to generate audience build configurations. For example, the user can provide an additional request to modify the criteria used in recommending a particular audience build configuration.

In some embodiments, the second response message UI element 340 queries the user for additional information for generating a subsequence audience build configuration and/or modifying the recommended audience build configurations.

FIG. 4 illustrates an example audience builder configuration system, in accordance with some embodiments. The audience builder configuration system 400 is configured to generate one or more recommended audience build configurations. The audience builder configuration system 400 includes an intent extraction module 420, a machine-learning model 425, an attribute similarity search module 450, an audience builder configuration similarity search module 460, and a response generation module 470. The audience builder configuration system 400 can further include first embeddings 435, first attribute intents 430, second attribute intents 440, and second embeddings 445, each of which can be stored in memory. The audience builder configuration system 400 can include or is in communication with a user device 410 (e.g., one or more user computing devices 16, 18, 20 and/or any other device described above in reference to FIG. 1). The audience builder configuration system 400 and/or one or more components thereof can be included in an audience configuration computing device 4 (FIG. 1).

The user device 410 can include an audience build configuration module 415 and/or a campaign generation module 480. The audience build configuration module 415 allows a user 405 to interface with the audience builder configuration system 400. For example, the audience build configuration module 415 can initiate an application at the user device 410 and present a UI, such as the audience builder UI 300, in the user device 410. Alternatively, or in addition, the user device 410 can access the audience builder UI 300 via a browser or other web application. The campaign generation module 480 allows the user 405 to initiate or build an audience for a campaign in accordance with a selected recommended audience build configuration. Alternatively, or in addition, in some embodiments, the user 405 can initiate or build an audience for a campaign in accordance with the selected recommended audience build configuration via a browser or other web application.

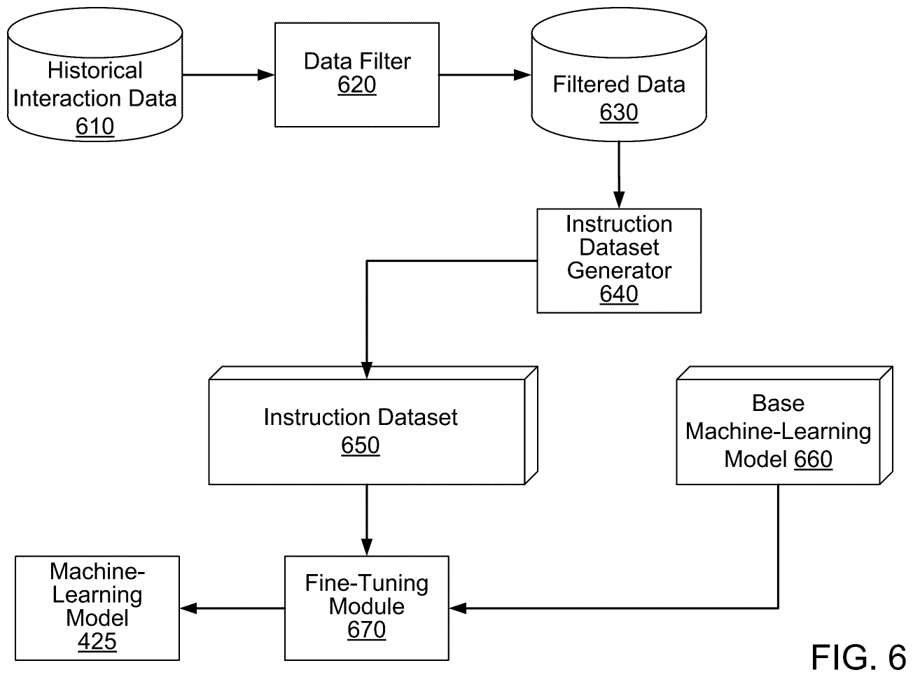

The audience builder configuration system 400 is configured to receive a request from the user 405. The request can include an audience description, which can include one or more audience parameters and/or product parameters. For example, an example request can be “help me build audience of users aged 18-35 who purchased Brand A's cereals in the last 3 months to 1 year.” Another example request can be “I want to show ads to users who purchased low calorie soft drinks.” The audience builder configuration system 400 uses the intent extraction module 420 and the machine learning model 425 to determine an audience intent based on, at least, the request. In particular, intent extraction module 420 and the machine-learning model 425 extract one or more of first attribute intents 430 and second attribute intents 440 from the request (e.g., a text input). In some embodiments, the intent extraction module 420 and the machine-learning model 425 are custom fine-tuned large language models (LLMs) that extract first attribute intents 430 and/or second attribute intents 440. Fine-tuning of the intent extraction module 420 and the machine-learning model 425 is described below in reference to FIG. 6.

The first attribute intents 430 can be product attribute intents 440 and the second attribute intents can be consumer attribute intents. The first attribute intents 430 can include one or more of a product description, a product brand, a product category, and/or other product information. The second attribute intents 440 can include one or more of gender, age, location, seasonality, persona, income, demographics, and/or other consumer data. The audience builder configuration system 400 can use additional attribute intents, such as goal attribute intent (e.g., audience size, reach threshold, performance threshold, etc.) and miscellaneous attribute intent (e.g., a look-back window (or other predetermined window), engagement frequency threshold, etc.).

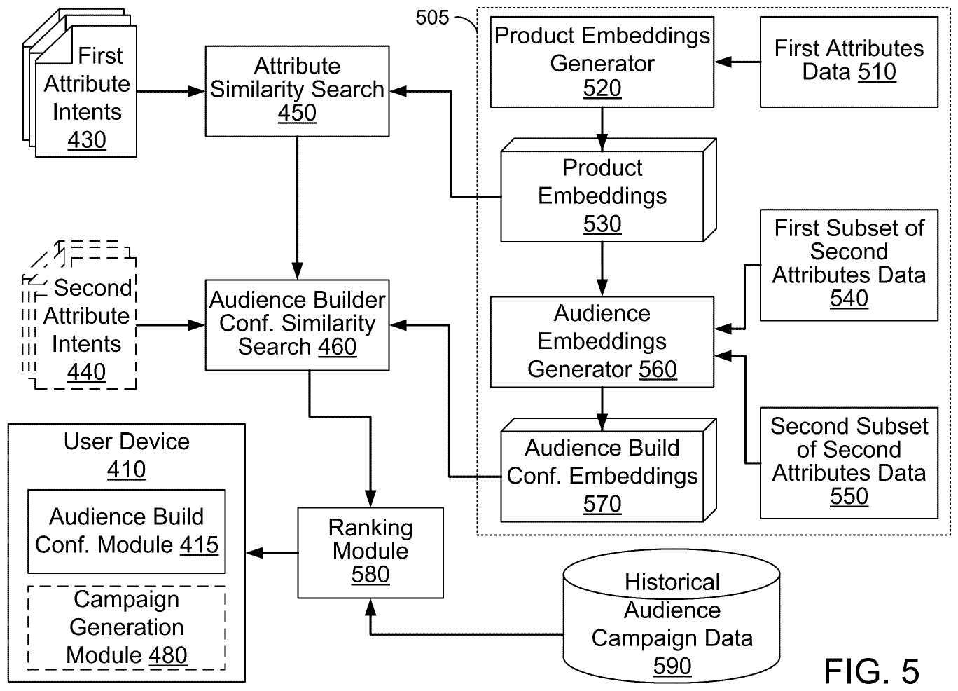

The audience builder configuration system 400 provides the first attribute intents 430 to the attribute similarity search module 450. The attribute similarity search module 450 compares the first attribute intents 430 against one or more first embeddings 435 to identify a subset 437 of the first embeddings 435 satisfying first similarity criteria. In some embodiments, the one or more first embeddings 435 may be (predetermined) product embeddings. The first embeddings 435 may be determined using one or more models as described below in reference to FIG. 5. The subset 437 of the first embeddings 435 satisfying the first similarity criteria are then provided to the audience builder configuration similarity search module 460. For example, product attribute intents determined by the intent extraction module 420 and the machine learning model 425 are compared against product embeddings to identify a subset of the product embeddings that satisfy the first similarity criteria. The identified subset 437 of the first embeddings 435 are provided to the audience builder configuration similarity search module 460. In some embodiments, the attribute similarity search module 450 uses Approximate Nearest Neighbor (ANN) to search and identify the subset of the first embeddings 435 for the given first attribute intents 430.

The audience builder configuration similarity search module 460 receives the subset 437 of the first embeddings 435 and compares the subset of first embeddings 435 against one or more second embeddings 445 to identify a subset of second embeddings 447 satisfying second similarity criteria. In some embodiments, the one or more second embeddings 445 are (predetermined) audience build configuration embeddings. The second embeddings 445 may be determined using one or more models as described below in reference to FIG. 5. The subset of second embeddings 447 satisfying the second similarity criteria are then provided to the response generation module 470. For example, the subset of first embeddings 437 can be compared against audience build configuration embeddings 445 to identify the subset of second embeddings 447 that satisfy the second similarity criteria. The subset of second embeddings 447 are provided to the response generation module 470. Alternatively, in some embodiments, the audience builder configuration similarity search module 460 also receives the second attribute intents 440, and compares the subset of first embeddings 437 and the second attribute intents 440 against the one or more second embeddings 445 to identify the subset of second embeddings 447 satisfying second similarity criteria. In some embodiments, the audience builder configuration similarity search module 460 uses ANN to search and identify the subset of second embeddings 447 for the given subset of first embeddings 437 and, optionally, the second attribute intents 440.

In some embodiments, the subset of second embeddings 447 includes second embeddings 445 that satisfy a matching threshold when compared against historical audience build configurations. Additional information on selection of the recommended audience build configurations is provided below in reference to audience build configuration recommender system (FIG. 5), which is a retrieval and ranking system that provides an optimal set of audience build configurations for a given set of first attribute intents 430 (e.g., product attributes) and/or second attribute intents 440 (e.g., consumer attributes).

The response generation module 470 receives the subset of second embeddings 447 and converts the subset of second embeddings 447 into one or more recommended audience build configurations. The recommended audience build configurations are in human readable text format. The recommended audience build configurations are presented to the user 405 via the user device. For example, as shown in FIG. 3B, the recommended audience build configurations can be presented as one or more recommended audience build configuration UI elements 315. In some embodiments, the recommended audience build configurations include one or more of a new audience building recommendation, a reach optimized recommendation, a conversion rate (or performance) optimized recommendation, and a balanced optimized recommendation. In some embodiments, one or more of the recommended audience build configurations are pre-built or predefined (or historical audience build configurations that reused if matching criteria or similarity criteria are satisfied).

Each of the recommendations is based on the request provided by the user 405. For example, in response to the request to “build [an] audience of users aged 18-35 who purchased Brand A's cereals in the last 3 months to 1 year,” the recommended audience build configurations can include i) a new audience recommendation with rule-based criteria including 300 similar items, 11 product categories, a look-back window of 1 year, age demographics of 18 to 35 years; ii) a pre-built audience recommendation that is reach optimized and includes predetermined criteria, such as brand affinity, brand A, breakfast cereals product categories, snack bars product categories, and other product categories; and iii) a pre-built audience recommendation that is performance optimized and includes predetermined criteria, such as buyers of brand A's product C in last 12 months. In another example, in response to the request to “show ads to users who purchased low calorie soft drinks,” the recommended audience build configurations can include i) a new audience recommendation with rule-based criteria including 165 similar items, 6 product types such as Drink mixes, Soda pop etc., and a look-back window of 1 year; ii) a pre-built audience recommendation that is reach optimized and includes predetermined criteria, such as sugar-free and/or low-calorie energy drinks purchaser of last 12 months; and iii) a pre-built audience recommendation that is performance optimized and includes predetermined criteria, such as propensity to purchase Brand D on-line and/or in-store.

The user 405 can select any one of the recommended audience build configuration to generate a campaign. The campaign is generated in accordance with the selected audience build configuration. In some embodiments, the campaign is generated by the campaign generation module 480.

FIG. 5 illustrates an audience build configuration recommender system, in accordance with some embodiments. The audience build configuration recommender system includes an embeddings generation system 505. The embeddings generation system 505 generates one or embeddings, such first embeddings 435 and second embeddings 445 described above in reference to FIG. 4. The embeddings generation system 505 includes first attributes data 510, a products embeddings generator 520, a first subset of second attributes data 540, a second subset of second attributes data 550, and an audience embeddings generator 560. The products embeddings generator 520 uses the first attributes data 510 to generate product embeddings 530. The audience embeddings generator 560 uses the first subset of second attributes data 540 and the second subset of second attributes data 550 to generate audience build configuration embeddings 570.

The first attributes data 510 can include one or more of a product name, a brand name, product taxonomies, a product gender, a product material, a product color, product description, a product category, and/or other product information. The first subset of second attributes data 540 can include audience targeting item-set metadata, such as targeted product data or metadata. The second subset of second attributes data 550 can include audience miscellaneous metadata, such as audience demography, seasonality, audience type, and/or campaign duration.

The embeddings generated by the embeddings generation system 505 are used to rank and recommend audience build configurations. For example, embeddings generated by the embeddings generation system 505 are used by the attribute similarity search module 450 and the audience builder configuration similarity search module 460 to determine recommend audience build configurations that are ranked by the ranking module 580. For example, the attribute similarity search module 450 receives first attribute intents 430 (e.g., product attribute intents) and identifies a subset of first embeddings 435 (e.g., subset of product embeddings 530) that satisfy first similarity criteria. The audience builder configuration similarity search module 460 receives the subset of first embeddings 435 and, in some embodiments, the second attribute intents 440 (e.g., consumer attribute intents) and identifies a subset of second embeddings 445 (e.g., subset of audience build configuration embeddings 570) that satisfy second similarity criteria. The subset of second embeddings 445 are then provided to the ranking module 580 for ranking the recommended audience build configurations as described below.

In some embodiments, the ranking module 580 ranks the recommended audience build configurations based on historical (ad) campaign performances. For example, the ranking module 580 can receive the subset of audience build configuration embeddings 570 (e.g., recommended audience build configurations) and historical audience campaign data 590 to rank the subset of audience build configuration embeddings 570. The ranked recommended audience build configurations are provided to the user 405 via the user device 410. Although not shown, the output of the ranking module 580 is provided to the response generation module 470, which converts the recommended audience build configurations into human readable text format. In some embodiments, the ranking module 580 determines matching scores, audience impact scores, and/or other measurable statistics for each recommended audience build (which can be presented to the user 405 as shown and described above in reference to FIG. 3B).

In some embodiments, a plurality of recommended audience build configurations are presented at the user device 410. In some embodiments, the plurality of recommended audience build configurations presented at the user device 410 includes at least three recommended audience build configurations. In some embodiments, the at least three recommended audience build configurations include a new audience building recommendation, a reach optimized recommendation, a conversion rate (or performance) optimized recommendation. In some embodiment, the reach optimized recommendation and the conversion rate optimized recommendation are pre-built or predefined.

FIG. 6 illustrates fine-tuning of a machine-learning model, in accordance with some embodiments. In particular, FIG. 6 shows LLM fine-tuning steps taken to build the intent extraction module 420. The LLM fine-tuning steps include providing historical interaction data 610 to a data filter 620. The historical interaction data 610 is stored in memory and includes historical data related to how users build audiences. The historical interaction data 610 can optionally include audience descriptions, which includes information and/or informational briefs about the audience in raw text. The data filter 620 applies custom heuristics to clean the raw datasets provided by the historical interaction data 610. The filtered data 630 is stored in memory.

The instruction dataset generator 640 receives the filtered data 630 and generates instruction tuning training dataset for the LLM fine-tuning. In some embodiments, the instruction tuning training dataset for the LLM fine-tuning includes instructions for identifying consumer and item attributes from an input text, and instructions for preparing a response. The instructions are stored as an instruction dataset 650. The stored instructions from the instruction dataset 650 are provided to a fine-tuning module 670, which fine-tunes a base machine-learning model 660. In some embodiments, the fine-tuning module 670 uses a Quantized Low Rank Adapter to fine-tune the base machine-learning model 660.

The fine-tuning module 670 trains the machine-learning model 425, which is a custom fine-tuned LLM that can process (advertiser) queries and/or extract relevant attributes, such as product attributes and/or consumer attributes. In some embodiments, the extracted relevant attributes conform with predetermined taxonomies. In some embodiments, the product attributes include one or more of a product name, a description, a brand, a category, etc. In some embodiments, the consumer attributes include demographics, seasonality, persona, etc.

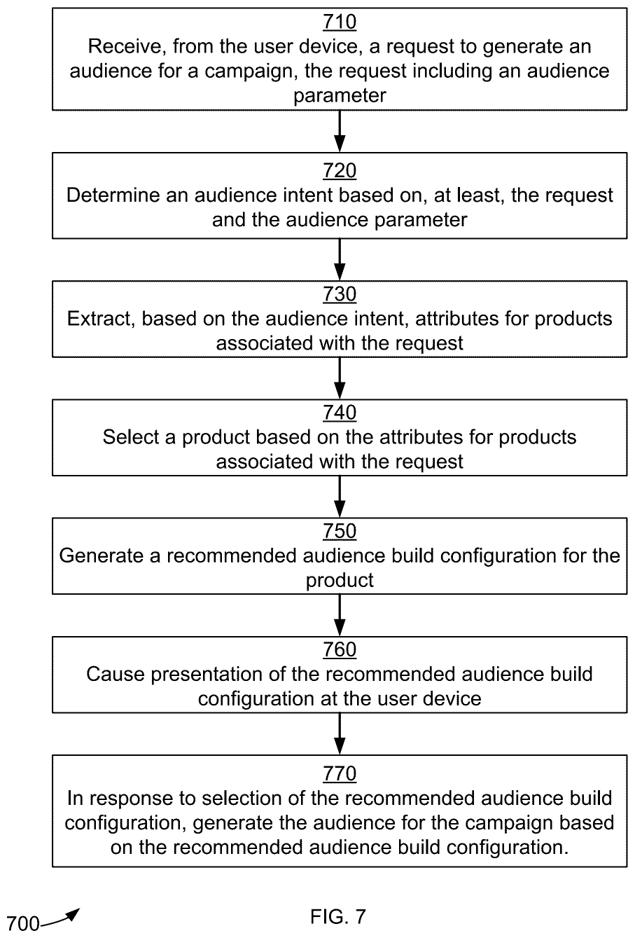

FIG. 7 is a flowchart illustrating a method for generating an audience for a campaign, in accordance with some embodiments. The method 700 shows various steps of the method. Although embodiments are discussed herein including application of certain steps and/or processes, it will be appreciated that various elements of the method 700 may be performed in various orders and/or performed by additional and/or alternative processes or system elements as those disclosed herein. The steps of the method 700 can be performed by one or more processors (e.g., CPUs, GPUs, etc.) of a system (e.g., an audience configuration computing device 4 or any other device described above in reference to FIG. 1). At least some of the operations shown in FIG. 7 correspond to instructions stored in a computer memory or computer-readable storage medium (e.g., storage, RAM, and/or memory). Operations of the method 700 can be performed by a single device alone or in conjunction with one or more processors and/or hardware components of another communicatively coupled device and/or instructions stored in memory or computer-readable medium of the other device communicatively coupled to the system. In some embodiments, the various steps of the method 700 described herein are interchangeable and/or optional, and respective steps of the methods 700 are performed by any of the aforementioned devices, systems, or combination of devices and/or systems. For convenience, the method steps will be described below as being performed by particular component or device (e.g., the audience configuration computing device 4), but should not be construed as limiting the performance of the operation to the particular device in all embodiments.

At step (710), the method 700 includes receive, from a user device, a request to generate an audience for a campaign. The request can include an audience parameter (e.g., an audience information or description and/or an audience targeted by the request). The method 700 includes, at step (720), determining an audience intent based on, at least, the request and the audience parameter, and, at step (730), extracting, based on the audience intent, attributes for products associated with the request. For example, as described above in reference to FIG. 4, a request provided by the user 405 is provided to an intent extraction module 420 and a machine-learning model 425, which determine first attribute intents 430 and, optionally, second attribute intents 450. An audience intent can be product attribute intents, consumer attribute intents, and/or other intents described herein.

At step (740), the method 700 includes selecting a product based on the attributes for products associated with the request. At step (750), the method 700 includes generating a recommended audience build configuration for the product. For example, as described above in reference to FIG. 4, an attribute similarity search 450 identifies a subset of product embeddings and an audience builder configuration similarity search module 460 uses the subset of product embeddings to determine recommended audience build configurations. The recommended audience build configurations can be provided to a response generation module 470, which converts the recommended audience build configurations into human readable text. And, at step (760), the method 700 includes causing presentation of the recommended audience build configuration at the user device.

At step (770), the method 700 includes, in response to selection of the recommended audience build configuration, generating the audience for the campaign based on the recommended audience build configuration. In other words, the user can initiate an advertisement campaign based on the selected recommended audience build configuration.

In some embodiments, the recommended audience build configuration is one of a new audience building recommendation, a reach optimizes recommendation, a conversion rate optimized recommendation, and a balanced optimized recommendation.

In some embodiments, the recommended audience build configuration is associated with one or more of a matching score, a reach score, and/or a performance score; and causing presentation of the recommended audience build configuration includes presenting one or more of the matching score, the reach score, and/or the performance score.

In some embodiments, the method 700 further includes, in response to a subsequent request to modify the recommended audience build configuration, determining an updated audience intent based on, at least, i) the request, ii) the audience parameter, and iii) the subsequent request to modify the recommended audience build configuration. The method also includes extracting, based on the audience intent, updated attributes for products associated with the request; selecting another product based on the updated attributes for products associated with the request; generating another recommended audience build configuration for the product; and causing presentation of the other recommended audience build configuration at the user device. The method 700, in response to selection of the other recommended audience build configuration, generating the audience for the campaign based on the other recommended audience build configuration.

In some embodiments, the recommended audience build configuration for the product is one of a plurality of recommended audience build configurations for the product; generating the recommended audience build configuration for the product includes generating the plurality of recommended audience build configurations for the product; and causing presentation of the recommended audience build configuration includes causing presentation of the plurality of recommended audience build configurations for the product. In some embodiments, the plurality of recommended audience build configurations for the product are ranked; and causing presentation of the plurality of recommended audience build configurations for the product includes presenting the plurality of recommended audience build configurations for the product in a ranked order (e.g., ascending or descending). In some embodiments, the ranked order is based on match score, reach score, or performance score.

In some embodiments, the method 700 includes extracting, based on the audience intent, attributes for consumers associated with the request, and selection of the product is further based on the attributes for consumers associated with the request.

In some embodiments, the attributes for products associated with the request include one or more of a product name, a brand name, product taxonomies, a product gender, a product color, and/or a product material.

In some embodiments, the method 700 includes extracting, based on the audience intent, attributes for consumers associated with the request; and selection of the product is further based on the attributes for consumers associated with the request. In some embodiments, the attributes for consumers associated with the request include one or more of gender, age, location, demographics, and/or income.

In some embodiments, the request includes a product parameter and determination of the audience intent is further based on the product parameter. For example, the request can identify a particular brand, a particular product, a particular brand category etc.

In accordance with some embodiments, a non-transitory computer readable storage medium including instructions that, when executed by a computing device, cause the computer device to perform steps corresponding to method 700.

In accordance with some embodiments, a system including an audience configuration computing device, a user device, and/or other device describe above in FIG. 1, the system configured to perform the steps of method 700.

In accordance with some embodiments, a computing device (e.g., an audience configuration computing device, a user device, and/or other device describe above in FIG. 1) configured to perform the steps of method 700.

Although the subject matter has been described in terms of example embodiments, it is not limited thereto. Rather, the appended claims should be construed broadly, to include other variants and embodiments, which may be made by those skilled in the art.

What is claimed is:

1. A system, comprising:
a database;
a processor; and
a non-transitory memory storing instructions, that when executed, cause the processor to:
receive, from a user device, a request to generate an audience for a campaign, the request including an audience parameter;
determine an audience intent based on the request and the audience parameter;
extract, based on the audience intent, attributes for products associated with the request;
select a product based on the attributes for products associated with the request;
generate a recommended audience build configuration for the product;
cause presentation of the recommended audience build configuration at the user device; and
in response to selection of the recommended audience build configuration, generate the audience for the campaign based on the recommended audience build configuration.

2. The system of claim 1, wherein the recommended audience build configuration is associated with one or more of a new audience building recommendation, a reach optimized recommendation, a conversion rate optimized recommendation, and a balanced optimized recommendation.

3. The system of claim 1, wherein:
the recommended audience build configuration is associated with one or more of a matching score, a reach score, and/or a performance score; and
causing presentation of the recommended audience build configuration includes presenting one or more of the matching score, the reach score, and/or the performance score.

4. The system of claim 1, wherein the instructions, when executed, cause the processor to:
in response to a subsequent request to modify the recommended audience build configuration:
determine an updated audience intent based on, at least, the request, the audience parameter, and the subsequent request to modify the recommended audience build configuration;
extract, based on the updated audience intent, updated attributes for products associated with the request;
select an additional product based on the updated attributes for products associated with the request;
generate an additional recommended audience build configuration for the additional product;
cause presentation of the additional recommended audience build configuration at the user device; and
in response to selection of the additional recommended audience build configuration, generate the audience for the campaign based on the additional recommended audience build configuration.

5. The system of claim 1, wherein:
the recommended audience build configuration for the product is one of a plurality of recommended audience build configurations for the product;
generating the recommended audience build configuration for the product includes generating the plurality of recommended audience build configurations for the product; and
causing presentation of the recommended audience build configuration includes causing presentation of the plurality of recommended audience build configurations for the product.

6. The system of claim 5, wherein:
the plurality of recommended audience build configurations for the product are ranked in a ranked order based on one or more of a matching score, a reach score, and/or a performance score; and
causing presentation of the plurality of recommended audience build configurations for the product includes presenting the plurality of recommended audience build configurations for the product in the ranked order.

7. The system of claim 1, wherein the attributes for products associated with the request include one or more of a product name, a brand name, product taxonomies, a product gender, a product color, and/or a product material.

8. The system of claim 1, wherein the instructions, when executed, cause the processor to extract, based on the audience intent, attributes for consumers associated with the request, wherein selection of the product is further based on the attributes for consumers associated with the request.

9. The system of claim 8, wherein the attributes for consumers associated with the request include one or more of gender, age, location, and/or income.

10. The system of claim 1, wherein the request includes a product parameter and determination of the audience intent is further based on the product parameter.

11. A computer-implemented method, comprising:
receiving, from a user device, a request to generate an audience for a campaign, the request including an audience parameter;
determining an audience intent based on the request and the audience parameter;
extracting, based on the audience intent, attributes for products associated with the request;
selecting a product based on the attributes for products associated with the request;
generating a recommended audience build configuration for the product;
causing presentation of the recommended audience build configuration at the user device; and
in response to selection of the recommended audience build configuration, generating the audience for the campaign based on the recommended audience build configuration.

12. The computer-implemented method of claim 11, wherein the recommended audience build configuration is associated with one or more of a new audience building recommendation, a reach optimized recommendation, a conversion rate optimized recommendation, and a balanced optimized recommendation.

13. The computer-implemented method of claim 11, wherein:
the recommended audience build configuration is associated with one or more of a matching score, a reach score, and/or a performance score; and
causing presentation of the recommended audience build configuration includes presenting one or more of the matching score, the reach score, and/or the performance score.

14. The computer-implemented method of claim 11, further comprising:
in response to a subsequent request to modify the recommended audience build configuration:
determining an updated audience intent based on, at least, the request, the audience parameter, and the subsequent request to modify the recommended audience build configuration;
extracting, based on the updated audience intent, updated attributes for products associated with the request;
selecting an additional product based on the updated attributes for products associated with the request;
generating an additional recommended audience build configuration for the additional product;
causing presentation of the additional recommended audience build configuration at the user device; and
in response to selection of the additional recommended audience build configuration, generating the audience for the campaign based on the additional recommended audience build configuration.

15. The computer-implemented method of claim 11, wherein:
the recommended audience build configuration for the product is one of a plurality of recommended audience build configurations for the product;
generating the recommended audience build configuration for the product includes generating the plurality of recommended audience build configurations for the product; and
causing presentation of the recommended audience build configuration includes causing presentation of the plurality of recommended audience build configurations for the product.

16. A non-transitory computer readable medium having instructions stored thereon, wherein the instructions, when executed by at least one processor, cause at least one device to perform operations comprising:
receiving, from a user device, a request to generate an audience for a campaign, the request including an audience parameter;
determining an audience intent based on the request and the audience parameter;
extracting, based on the audience intent, attributes for products associated with the request;
selecting a product based on the attributes for products associated with the request;
generating a recommended audience build configuration for the product;
causing presentation of the recommended audience build configuration at the user device; and
in response to selection of the recommended audience build configuration, generating the audience for the campaign based on the recommended audience build configuration.

17. The non-transitory computer readable medium of claim 16, wherein the recommended audience build configuration is associated with one or more of a new audience building recommendation, a reach optimized recommendation, a conversion rate optimized recommendation, and a balanced optimized recommendation.

18. The non-transitory computer readable medium of claim 16, wherein:
the recommended audience build configuration is associated with one or more of a matching score, a reach score, and/or a performance score; and
causing presentation of the recommended audience build configuration includes presenting one or more of the matching score, the reach score, and/or the performance score.

19. The non-transitory computer readable medium of claim 16, wherein:
the recommended audience build configuration for the product is one of a plurality of recommended audience build configurations for the product;
generating the recommended audience build configuration for the product includes generating the plurality of recommended audience build configurations for the product; and
causing presentation of the recommended audience build configuration includes causing presentation of the plurality of recommended audience build configurations for the product.

20. The non-transitory computer readable medium of claim 19, wherein:
the plurality of recommended audience build configurations for the product are ranked in a ranked order based on one or more of a matching score, a reach score, and/or a performance score; and
causing presentation of the plurality of recommended audience build configurations for the product includes presenting the plurality of recommended audience build configurations for the product in the ranked order.
